(19) United States
(12) Patent Application Publication
(10) Pub. No.: US 2007/0257892 A1
(43) Pub. Date: Nov. 8, 2007

(54) DATA PROCESSING SYSTEM AND METHOD FOR TOUCH PAD

(75) Inventors: Che-Hsien Hu, Taipei City (TW); Yi-Hung Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/459,362

(22) Filed: Jul. 23, 2006

(30) Foreign Application Priority Data
May 3, 2006 (TW) 95115701

(51) Int. Cl. G06F 3/041

(52) U.S. Cl. 345/173

(57) ABSTRACT

A data processing system for touch pad and the method thereof are disclosed. The system includes the touch pad and an embedded controller. First, a sensor device in the touch pad receives a sensing signal and stores the sensing signal in the touch pad. Next, the embedded controller receives the sensing signal, converts the sensing signal into a signal acceptable to a terminal, and then transmits the converted sensing signal to the terminal. According to the present invention, the microprocessor, RAM (Random Access Memory), and ROM (Read-Only Memory) in the touch pad can be omitted to reduce the manufacturing cost of the touch pad module.

### CROSS-REFERENCE TO RELATED APPLICATION

This application claims the priority benefit of Taiwan application serial no. 95115701, filed on May 3, 2006. All disclosure of the Taiwan application is incorporated herein by reference.

### BACKGROUND OF THE INVENTION

1. Field of the Invention

The present invention relates to a data processing system for touch pad and the method thereof. More particularly, the present invention relates to a data processing system for touch pad, wherein data is processed and converted by using an embedded controller, and the method thereof.

2. Description of Related Art

Because of the rapid development of electronic industry, portable electronic apparatuses have become widely used. However, since some input devices such as mouse and keyboard can not be carried about conveniently, touch pad has been introduced as an input device. FIG. 1 is a block diagram illustrating a conventional data processing system for touch pad. Referring to FIG. 1, a touch pad module 110, an embedded controller (EC) 120, a terminal 130, a first transmission interface 140, and a second transmission interface 150 are included. The touch pad module 110 includes a sensor device 111, a processor 112, a random access memory (RAM) 113, and a read-only memory (ROM) 114. When the sensor device 111 in the touch pad module 110 receives a signal (a user is using the touch pad), the sensor device 111 sends a sensing signal to the processor 112 in the touch pad module 110. The processor 112 converts the sensing signal into a signal of PS2 (personal system 2) format and transmits the signal to the RAM 113. The EC 120 reads the signal in the RAM 113 through the first transmission interface 140 and directly transmits the signal to the terminal 130 through the second transmission interface 150 for subsequent processing. Wherein the ROM 114 in the touch pad module 110 is electrically connected to the processor 112 and stores a firmware program code which controls the conversion of data format and the duration of data transmission.

In overview, the structure of the conventional touch pad data processing has at least the following disadvantages:

1. The sensing signal has to be converted by the touch pad module first before it is transmitted to the terminal by the EC for subsequent operations, which makes the data processing flow very complicated; accordingly the data processing has to take very long time.

2. The touch pad module has to be disposed with microprocessor, RAM, and ROM for performing data conversion, accordingly, the cost of the touch pad is very high.

3. The EC provides only the function of data transmission, so that the resources of the EC itself are wasted.

### SUMMARY OF THE INVENTION

Accordingly, the present invention is directed to provide a data processing system for touch pad, wherein sensing signals of the touch pad are processed by an embedded controller (EC) so as to simplify the data processing structure in the touch pad and to reduce the manufacturing cost of the touch pad.

According to another aspect of the present invention, a touch pad data processing system is provided, wherein sensing signals of the touch pad are processed by a software at the terminal so as to reduce hardware in the touch pad and the load of system hardware, and to increase the flexibility of the data processing structure of the touch pad.

According to yet another aspect of the present invention, a touch pad data processing method is provided, wherein sensing signals of the touch pad are processed by an EC so as to simplify the data processing flow and the duration thereof in the touch pad and to improve the efficiency of data processing.

According to yet another aspect of the present invention, a touch pad data processing method is provided, wherein sensing signals of the touch pad are processed by a software at the terminal so as to simplify the data processing flow in the touch pad and to speed up the data processing.

To achieve the aforementioned and other objectives, the present invention provides a touch pad data processing system including an EC and a touch pad. Wherein the touch pad is electrically connected to the EC and communicates with the EC through a transmission interface, and the touch pad has a sensor device for receiving a first sensing signal and storing the first sensing signal in the touch pad. When the EC receives the first sensing signal through the transmission interface, the EC converts the first sensing signal into a second sensing signal and outputs the second sensing signal.

According to the touch pad data processing system in an exemplary embodiment of the present invention, the touch pad uses a register for storing the first sensing signal.

According to the touch pad data processing system in an exemplary embodiment of the present invention, the foregoing register is built in the sensor device.

According to the touch pad data processing system in an exemplary embodiment of the present invention, the foregoing transmission interface is personal system 2 (PS2) interface, serial peripheral interface (SPI), or system management bus (SMBUS).

According to the touch pad data processing system in an exemplary embodiment of the present invention, the EC outputs the second sensing signal to the terminal, and the terminal may be, for example, an operating system.

According to the touch pad data processing system in an exemplary embodiment of the present invention, the EC communicates with the terminal through low pin count (LPC) interface.

According to the touch pad data processing system in an exemplary embodiment of the present invention, the second sensing signal is of PS2 format.

To achieve the aforementioned and other objectives, the present invention further provides a touch pad data processing system including an EC, a touch pad, and a terminal. Wherein, the touch pad is electrically connected to the EC and communicates with the EC through a first transmission interface, and the touch pad has a sensor device for receiving the first sensing signal and storing the first sensing signal in the touch pad. The terminal is electrically connected to the EC and communicates with the EC through the second transmission interface. When the EC receives the first sensing signal through the first transmission interface, the EC outputs the first sensing signal to the terminal, and a software at the terminal converts the first sensing signal into a second sensing signal.

According to the touch pad data processing system in an exemplary embodiment of the present invention, the touch pad uses a register for storing the first sensing signal.

According to the touch pad data processing system in an exemplary embodiment of the present invention, the foregoing register is built in the sensor device.

According to the touch pad data processing system in an exemplary embodiment of the present invention, the first transmission interface is PS2 interface, SPI, or SMBUS.

According to the touch pad data processing system in an exemplary embodiment of the present invention, the second transmission interface is LPC interface.

According to the touch pad data processing system in an exemplary embodiment of the present invention, the second sensing signal is of PS2 format.

According to the touch pad data processing system in an exemplary embodiment of the present invention, the software at the terminal is a driver program.

To achieve the aforementioned and other objectives, the present invention further provides a touch pad data processing method. First, the first sensing signal is received and stored in the touch pad. Then, when the EC receives the first sensing signal through the transmission interface, the EC converts the first sensing signal into the second sensing signal and outputs the second sensing signal.

According to the touch pad data processing method in an exemplary embodiment of the present invention, the touch pad uses a register for storing the first sensing signal.

According to the touch pad data processing method in an exemplary embodiment of the present invention, the register is built in the sensor device of the touch pad.

According to the touch pad data processing method in an exemplary embodiment of the present invention, the transmission interface is PS2 interface, SPI, or SMBUS.

According to the touch pad data processing method in an exemplary embodiment of the present invention, the EC outputs the second sensing signal to the terminal, wherein the terminal is, for example, an operating system.

According to the touch pad data processing method in an exemplary embodiment of the present invention, the EC communicates with the terminal through LPC interface.

According to the touch pad data processing method in an exemplary embodiment of the present invention, the second sensing signal is of PS2 format.

To achieve the aforementioned and other objectives, the present invention further provides a touch pad data processing method. First, the first sensing signal is received and stored in the touch pad. Next, the EC receives the first sensing signal through the first transmission interface and outputs the first sensing signal to the terminal through the second transmission interface. Finally, a software at the terminal converts the first sensing signal into the second sensing signal.

According to the touch pad data processing method in an exemplary embodiment of the present invention, the touch pad uses a register for storing the first sensing signal.

According to the touch pad data processing method in an exemplary embodiment of the present invention, the foregoing register is built in the sensor device of the touch pad.

According to the touch pad data processing method in an exemplary embodiment of the present invention, the first transmission interface is PS2 interface, SPI, or SMBUS.

According to the touch pad data processing method in an exemplary embodiment of the present invention, the second transmission interface is LPC.

According to the touch pad data processing method in an exemplary embodiment of the present invention, the second sensing signal is of PS2 format.

According to the touch pad data processing method in an exemplary embodiment of the present invention, the software at the terminal is a driver program.

According to exemplary embodiments of the present invention, in the touch pad data processing method, sensing signals are processed by an EC or a software at terminal and are converted into system acceptable format, accordingly, the data processing flow and the duration thereof in the touch pad can be reduced and the data processing structure in the touch pad can be simplified, moreover, the manufacturing cost of the touch pad can be reduced.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a conventional data processing system for touch pad.

FIG. 2 is a block diagram illustrating the data processing system for a touch pad according to an embodiment of the present invention.

FIG. 3 is a flowchart illustrating the data processing method for a touch pad according to an embodiment of the present invention.

FIG. 4 is a block diagram illustrating the data processing system for a touch pad according to another embodiment of the present invention.

FIG. 5 is a flowchart illustrating the data processing method for a touch pad according to another embodiment of the present invention.

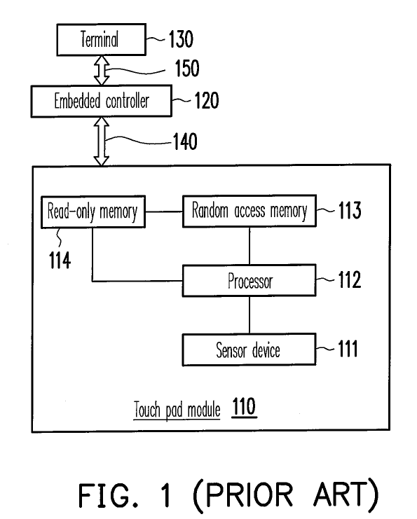

### DESCRIPTION OF EMBODIMENTS

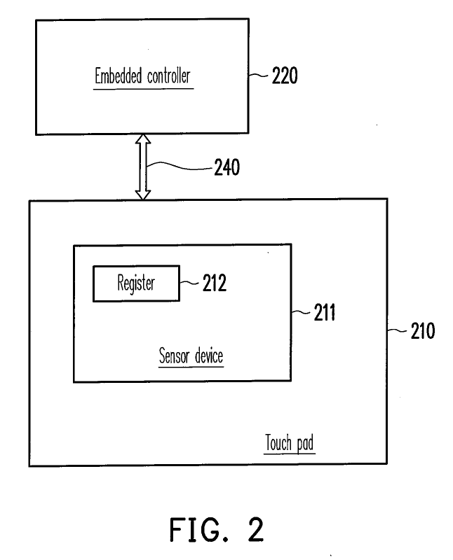

FIG. 2 is a block diagram illustrating the data processing system for a touch pad according to an embodiment of the present invention. Referring to FIG. 2, the touch pad data processing system 200 includes a touch pad 210, an embedded controller (EC) 220, and a transmission interface 240. The touch pad 210 is electrically connected to the EC 220 and communicates with the EC 220 through the transmission interface 240. The touch pad 210 has a sensor device 211 for receiving a first sensing signal.

Thus, when a user is using the touch pad 210, the sensor device 211 receives the first sensing signal and stores the first sensing signal into the touch pad 210. The EC 220 reads the first sensing signal stored in the touch pad 210 through the transmission interface 240 and converts the first sensing signal into a second sensing signal.

In the present embodiment, the touch pad 210 uses a register 212 to store the first sensing signal, and the register 212 is built in the sensor device 211. The touch pad 210 communicates with the EC 220 through the transmission interface 240, wherein the communication protocol used by the transmission interface 240 is, for example, personal system 2 (PS2) interface, serial peripheral interface (SPI), or system management bus (SMBUS). The second sensing signal is, for example, a data of PS2 format.

In the present embodiment, the EC 220 outputs the second sensing signal to a terminal. The terminal is, for example, an operating system, and the EC 220 communicates with the terminal through, for example, low pin count (LPC) interface. Below the touch pad data processing method in an embodiment of the present invention will be described in detail.

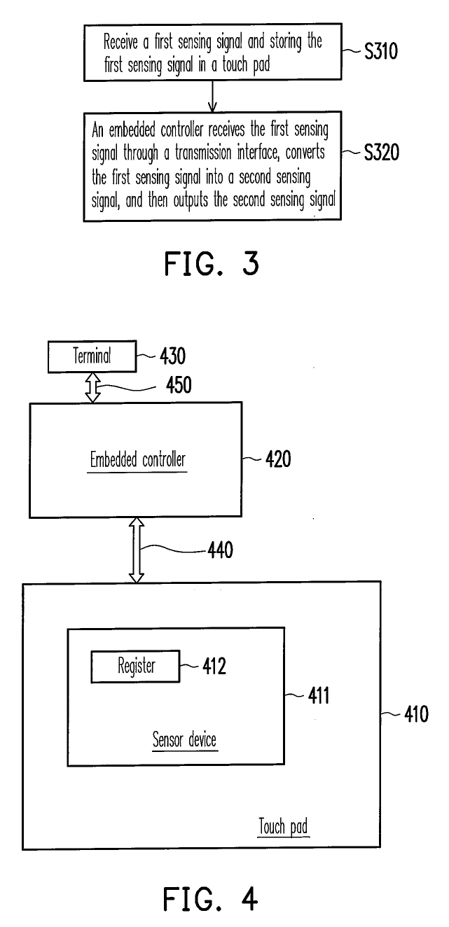

FIG. 3 is a flowchart illustrating the data processing method for touch pad according to an embodiment of the present invention. Referring to FIG. 3, first, the touch pad receives the first sensing signal and stores the first sensing signal in the touch pad (step S310). Next, the EC receives the first sensing signal through the transmission interface, and then the EC converts the first sensing signal into the second sensing signal and outputs the second sensing signal (step S320).

In the present embodiment, the touch pad uses, for example, a register for storing the first sensing signal and the register is built in the sensor device of the touch pad. The touch pad communicates with the EC through the transmission interface, wherein the communication protocol used by the transmission interface is PS2 interface, SPI, or SMBUS. The second sensing signal is, for example, a data of PS2 format.

In the present embodiment, the EC outputs the second sensing signal to the terminal, and the EC communicates with the terminal through LPC interface, wherein the terminal is an operating system (which refers to the operating system “Windows OS” in Window Operating System).

As described above, according to an embodiment of the present invention, the sensing signal is converted into system acceptable format by the EC, so that the resources of the EC itself can be fully utilized and the structure inside the touch pad is simplified, accordingly the cost of the touch pad is reduced.

Below the touch pad data processing system according to another embodiment of the present invention will be described. In this embodiment, the EC transmits the sensing signal directly to the terminal, and then the sensing signal is converted into a signal of system acceptable format by a software at the terminal.

FIG. 4 is a block diagram illustrating the data processing system for touch pad according to another embodiment of the present invention. Referring to FIG. 4, the touch pad data processing system 400 includes a touch pad 410, an EC 420, a terminal 430, a first transmission interface 440, and a second transmission interface 450. Wherein, the touch pad 410 is electrically connected to the EC 420 and communicates with the EC 420 through the first transmission interface 440, and the touch pad 410 has a sensor device 411 for receiving the first sensing signal and storing the first sensing signal into the touch pad 410. The EC 420 is electrically connected to the terminal 430 and communicates with the terminal 430 through the first transmission interface 450. In the present embodiment, the touch pad 410 uses, for example, a register 412 for storing the first sensing signal, and the register 412 is built in the sensor device 411.

When a user is using the touch pad 410, the sensor device 411 receives the first sensing signal and stores the first sensing signal into the register 412. The EC 420 reads the first sensing signal stored in the register 412 through the first transmission interface 440, and outputs the first sensing signal directly to the terminal 430 through the second transmission interface 450. Then the first sensing signal is converted into the second sensing signal by a software in the terminal 430.

In the present embodiment, the first transmission interface 440 is, for example, PS2 interface, SPI, or SMBUS, the communication protocol used by the second transmission interface 450 is, for example, LPC interface, and the second sensing signal is of, for example, PS2 format. The software at the terminal 430 is, for example, a driver program.

Below the touch pad data processing method according to another embodiment of the present invention will be described in detail.

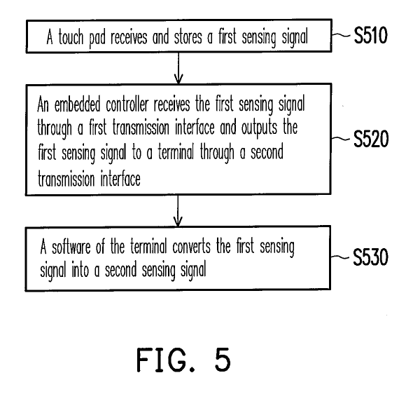

FIG. 5 is a flowchart illustrating the data processing method for touch pad according to another embodiment of the present invention. Referring to FIG. 5, first, the touch pad receives and stores the first sensing signal (step S510). Next, the EC receives the first sensing signal through the first transmission interface and outputs the first sensing signal to the terminal through the second transmission interface (step S520). Finally, the first sensing signal is converted into the second sensing signal by a software at the terminal (step S530). In the present embodiment, the terminal is, for example, an operating system, and the software at the terminal is, for example, a driver program.

In the present embodiment, the touch pad uses, for example, a register for storing the first sensing signal and the register is built in the sensor device of the touch pad. The touch pad communicates with the EC through the first transmission interface, and the communication protocol used by the first transmission interface is, for example, PS2 interface, SPI, or SMBUS.

In the present embodiment, the EC communicates with the terminal through the second transmission interface, and the second transmission interface is, for example, LPC interface, and the second sensing signal is, for example, a data of PS2 format, however, the foregoing description are not intended to limit the scope of the present invention.

Even the two embodiments described above are only used for respectively describing a touch pad data processing method of the present invention, it should be understood by those skilled in the art that one of the two embodiments can be used for performing the data processing of the first sensing signal so that the entire system can be more flexible. For example, a switch is designed in the EC for determining whether the function of the EC processing the first sensing signal is turned on. Thus, when the switch is turned on, the first sensing signal is processed by the EC and converted into the second sensing signal to be output; and when the switch is turned off, the EC does not process the first sensing signal, instead, the EC only transmits the first sensing signal to the terminal so that the first sensing signal can be processed by a software at the terminal.

In overview, according to the touch pad data processing method in the present invention, sensing signals of a touch pad are processed by an EC and are converted into data of system acceptable format, so that the data processing structure in the touch pad can be simplified and the manufacturing cost of the touch pad can be reduced accordingly. According to another touch pad data processing method of the present invention, sensing signals of the touch pad are processing by a software at the terminal, thus, the data processing flow can be simplified and the data processing duration can be reduced, accordingly the manufacturing cost of the touch pad can also be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data processing system for touch pad, comprising:
an embedded controller; and
a touch pad, electrically connected to the embedded controller, communicating with the embedded controller through a transmission interface, having a sensor device for receiving a first sensing signal and storing the first sensing signal in the touch pad;
wherein after the embedded controller has received the first sensing signal through the transmission interface, the embedded controller converts the first sensing signal into a second sensing signal and outputs the second sensing signal.

2. The touch pad data processing system as claimed in claim 1, wherein the touch pad uses a register for storing the first sensing signal.

3. The touch pad data processing system as claimed in claim 2, wherein the register is built in the sensor device.

4. The touch pad data processing system as claimed in claim 1, wherein the transmission interface is one of personal system 2 (PS2) interface, serial peripheral interface (SPI), and system management bus (SMBUS).

5. The touch pad data processing system as claimed in claim 1, wherein the embedded controller outputs the second sensing signal to a terminal, wherein the terminal is an operating system.

6. The touch pad data processing system as claimed in claim 5, wherein the embedded controller communicates with the terminal through a low pin count (LPC) interface.

7. The touch pad data processing system as claimed in claim 1, wherein the second sensing signal is of PS2 format.

8. A data processing system for touch pad, comprising:
an embedded controller;
a touch pad, electrically connected to the embedded controller, communicating with the embedded controller through a first transmission interface, having a sensor device for receiving a first sensing signal and storing the first sensing signal into the touch pad; and
a terminal, electrically connected to the embedded controller, communicating with the embedded controller through a second transmission interface;
wherein when the embedded controller has received the first sensing signal through the first transmission interface, the embedded controller outputs the first sensing signal to the terminal, and a software at the terminal converts the first sensing signal into a second sensing signal.

9. The touch pad data processing system as claimed in claim 8, wherein the touch pad uses a register for storing the first sensing signal.

10. The touch pad data processing system as claimed in claim 9, wherein the register is built in the sensor device.

11. The touch pad data processing system as claimed in claim 8, wherein the first transmission interface is one of PS2 interface, SPI, and SMBUS.

12. The touch pad data processing system as claimed in claim 8, wherein the second transmission interface is LPC interface.

13. The touch pad data processing system as claimed in claim 8, wherein the second sensing signal is of PS2 format.

14. The touch pad data processing system as claimed in claim 8, wherein the software at the terminal is a driver program.

15. A data processing method for touch pad, comprising:
receiving a first sensing signal and storing the first sensing signal in a touch pad; and
an embedded controller receiving the first sensing signal through a transmission interface, converting the first sensing signal into a second sensing signal, and then outputting the second sensing signal.

16. The touch pad data processing method as claimed in claim 15, wherein the touch pad uses a register for storing the first sensing signal.

17. The touch pad data processing method as claimed in claim 16, wherein the register is built in a sensor device of the touch pad.

18. The touch pad data processing method as claimed in claim 15, wherein the transmission interface is one of PS2 interface, SPI, and SMBUS.

19. The touch pad data processing method as claimed in claim 15, wherein the embedded controller outputs the second sensing signal to a terminal, wherein the terminal is an operating system.

20. The touch pad data processing method as claimed in claim 19, wherein the embedded controller communicates with the terminal through LPC interface.

21. The touch pad data processing method as claimed in claim 15, wherein the second sensing signal is of PS2 format.

22. A data processing method for touch pad, comprising:
receiving a first sensing signal and storing the first sensing signal into a touch pad;
an embedded controller receiving the first sensing signal through a first transmission interface and outputting the first sensing signal to a terminal through a second transmission interface; and
a software of the terminal converting the first sensing signal into a second sensing signal.

23. The touch pad data processing method as claimed in claim 22, wherein the touch pad uses a register for storing the first sensing signal.

24. The touch pad data processing method as claimed in claim 23, wherein the register is built in a sensor device of the touch pad.

25. The touch pad data processing method as claimed in claim 22, wherein the first transmission interface is one of PS2 interface, SPI, and SMBUS.

26. The touch pad data processing method as claimed in claim 22, wherein the second transmission interface is LPC interface.

27. The touch pad data processing method as claimed in claim 22, wherein the second sensing signal is of PS2 format.

28. The touch pad data processing method as claimed in claim 22, wherein the software at the terminal is a driver program.
